(19) United States
(12) Patent Application Publication
(10) Pub. No.: US 2011/0152443 A1
(43) Pub. Date: Jun. 23, 2011

(54) METHOD OF MANUFACTURING POLYMER MATERIAL

(75) Inventors: Kanako Ito, Kanagawa (JP); Daisuke Ito, Kanagawa (JP); Shinichi Uesaka, Kanagawa (JP)

(73) Assignee: SONY CORPORATION, Tokyo (JP)

(21) Appl. No.: 12/970,109

(22) Filed: Dec. 16, 2010

(30) Foreign Application Priority Data
Dec. 22, 2009 (JP) P2009-290120

(51) Int. Cl. C08L 27/20; C08L 27/16

(52) U.S. Cl. 524/546; 524/545

(57) ABSTRACT

A method of manufacturing a polymer material which is allowed to manufacture β-phase PVDF easily and stably in a short time is provided. The method of manufacturing a polymer material includes a step of mixing an ionic liquid and a polymer compound including α-phase polyvinylidene difluoride to form a mixture, and then heating the mixture.

### CROSS REFERENCES TO RELATED APPLICATIONS

The present application claims priority to Japanese Priority Patent Application JP 2009-290120 filed in the Japan Patent Office on Dec. 22, 2009, the entire content of which is hereby incorporated by reference.

### BACKGROUND

The present application relates to a method of manufacturing a polymer material including polyvinylidene difluoride (PVDF).

In recent years, ferroelectrics are used in various technical fields. The ferroelectrics are materials having an electric dipole without an external electric field and changing the direction of the electric dipole in response to an electric field. As the ferroelectrics, inorganic materials such as barium titanate (BaTiO₃), lead zirconate titanate (Pb(Zr, Ti)O₃) and sodium nitrite (NaNO₂) are widely known.

The ferroelectrics are applied to, in addition to capacitors in related art, devices, materials and the like in a large number of electronics fields which will be described below. The applications of the ferroelectrics include nonvolatile semiconductor memories such as ferroelectric memories using ferroelectricity (ferroelectric random access memories: FeRAMs), piezoelectric elements and actuators using a piezoelectric effect, insulating layers of field-effect transistors using dielectric properties, and nonlinear optical materials. As described above, the ferroelectrics are applied to various uses, and it is considered that the ferroelectrics have wider applicability.

In recent years, for the application of the ferroelectrics to memories directly using ferroelectricity, research and development of the ferroelectrics have been accelerated, and to achieve lighter and more flexible memories, organic materials have been studied.

As organic materials having ferroelectricity, in addition to a ferroelectric liquid crystal, PVDF which is a polymer material is known. For example, as described in solid state ionics, 178, 527-531, 2007, A. Martinelli et al., PVDF is a semicrystalline polymer having an α-, β- or γ-phase crystal structure or the like, and in general, α-phase PVDF does not display ferroelectricity, but β-phase PVDF specifically displays ferroelectricity.

To obtain β-phase PVDF, it is necessary to form an α-phase PVDF film and then uniaxially stretch the film or crystallize the film under high pressure. More specifically, first, a polymer blend formed by mixing α-phase PVDF and a polyamide is prepared. Next, the polymer blend is melt-kneaded and extruded at a high rotation speed of 500 rpm or over, and then the polymer blend is rolled to form a film. Finally, while an alternating electric field is applied to the film, poling treatment is performed on the film. Thus, a ferroelectric film of β-phase PVDF is obtained, for example, as described in Japanese Unexamined Patent Application Publication No. 2006-241195.

Moreover, as a technique relating to β-phase PVDF, a dried film (a β-phase vinylidene difluoride copolymer) of a solvent blend formed with use of dimethylacetamide or dimethylformamide as a solvent with high solubility is known, for example, as described in Japanese Unexamined Patent Application Publication No. 560-040137. Further, a FeRAM using β-phase PVDF for a ferroelectric layer is known, for example, as described in Published Japanese translation of PCT application No. 2008-541444.

### SUMMARY

Even though β-phase PVDF is a useful organic ferroelectric material, it is extremely difficult to obtain β-phase PVDF, because a large-scale apparatus and strict conditions are necessary to perform a stretching process, a rolling process or the like, and it is necessary to perform an additional process after forming a film; therefore, a complicated process is involved, and it takes a long time to perform the process, and there is concern for manufacturing stability.

It is desirable to provide a method of manufacturing a polymer material which is allowed to manufacture β-phase PVDF easily and stably in a short time.

According to an embodiment, there is provided a method of manufacturing a polymer material includes a step of mixing an ionic liquid and a polymer compound including α-phase polyvinylidene difluoride to form a mixture, and then heating the mixture.

In the method of manufacturing a polymer material according to the embodiment, when the ionic liquid and the polymer compound including α-phase polyvinylidene difluoride are mixed and then heated, the crystal structure of polyvinylidene difluoride is transformed from α phase to β phase. Therefore, β-phase polyvinylidene difluoride is allowed to be manufactured easily and stably in a short time.

Additional features and advantages are described herein, and will be apparent from the following Detailed Description and the figures.

### BRIEF DESCRIPTION OF THE FIGURES

FIG. 1 is a flow chart for describing a method of manufacturing a polymer material according to an embodiment.

FIG. 2 is a sectional view illustrating a configuration of an electrochemical capacitor to which the method of manufacturing a polymer material according to the embodiment is applied.

FIG. 3 is a measurement result (Experimental Example 3) by Raman spectroscopy.

FIG. 4 is a measurement result (Experimental Example 6) by Raman spectroscopy.

FIG. 5 is a measurement result (an ionic liquid only) by Raman spectroscopy.

### DETAILED DESCRIPTION

Embodiments of the present application will be described below in detail with reference to the drawings. Descriptions will be given in the following order.

1. Method of manufacturing polymer material

2. Application Example (electrochemical capacitor)

1. Method of manufacturing polymer material

Steps of Manufacturing Polymer Material

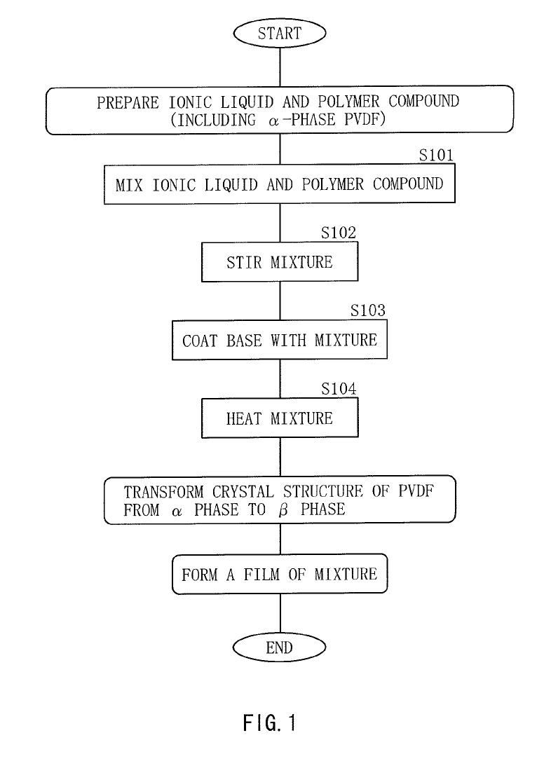

First, a method of manufacturing a polymer material according to an embodiment will be described below. FIG. 1 illustrates a flow of steps of manufacturing a polymer material.

The method of manufacturing a polymer material described herein is a method of obtaining β-phase PVDF with use of α-phase PVDF. β-phase PVDF obtained by the manufacturing method is used for various energy devices such as electrochemical capacitors, fuel cells and lithium-ion secondary batteries.

To manufacturing a polymer material, first, an ionic liquid and a polymer compound including α-phase PVDF are prepared.

The ionic liquid is variously called ambient temperature molten salt or room temperature molten salt. In Europe and the United States, a salt of which the melting point is 100° C. or lower is called ionic liquid.

As most of constituent ions of the ionic liquid are organic substances, a wide variety of derivatives are allowed to be used as the ionic liquid. Typical properties and functions of the ionic liquid are determined by a combination of a cation and an anion, but the kind of the ionic liquid used herein (the kinds of the cation and the anion) is not specifically limited.

The kind of the cation is broadly divided into an aliphatic amine cation and an aromatic amine cation. Examples of the aliphatic amine cation include an ion (DEME) represented by the following expression (1), and the like. Examples of the aromatic amine cation include an ion (EMI) represented by the following expression (2), and the like. Note that R1 and R2 in the expression (2) each are an alkyl group (the number of carbon atoms is not specifically limited), and R1 and R2 may be of the same kind or different kinds.

The anion is broadly divided into a chloroaluminate anion and a non-chloroaluminate anion. Examples of the chloroaluminate anion include a tetrachloroaluminum ion (AlCl₄⁻) and the like. Examples of the non-chloroaluminate anion include a tetrafluoroborate ion (BF₄⁻), a trifluoromethanesulfonate ion ((CF₃SO₂)₂N⁻), a nitrate ion (NO₃⁻) and the like.

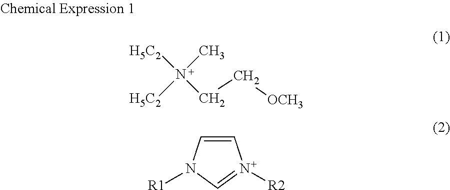

As the ionic liquid, a material having compatibility with the polymer compound is preferable, because the polymer compound is easily dispersed by the ionic liquid. More specifically, as represented by the following expression (3), a material (DEDE-BF₄) including DEME and BF₄⁻ as the cation and the anion, respectively, is preferable, because good solubility, good compatibility and good heat resistance are obtained. More specifically, in the case where the cation is EMI, a severe reductive decomposition reaction is developed at high temperature; therefore, the use temperature is limited to approximately 60° C. On the other hand, in the case where the cation is DEME, a reductive decomposition reaction is suppressed at high temperature; therefore, DEME is allowed to be used at approximately 150° C.

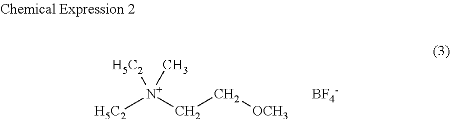

The kind of the polymer compound may be only α-phase PVDF or a copolymer including α-phase PVDF. The copolymer including α-phase PVDF means a material compolymerized with use of α-phase vinylidene difluoride (VDF) as one of a plurality of monomers. In other words, the copolymer including α-phase PVDF is a material formed by compolymerizing α-phase VDF and one kind or two or more kinds of monomers. The definition of “polymer material including β-phase PVDF” which will be described later is the same as that described herein. The polymer compound preferably has thermoplasticity, because β-phase PVDF ultimately formed is easily moldable.

As the polymer compound, the copolymer including α-phase PVDF is preferable. Examples of such a copolymer include a copolymer (PVDF-HFP) of α-phase vinylidene difluoride and hexafluoropropylene, and the like, because the copolymer has a high affinity for the ionic liquid; therefore, the copolymer is dispersed more easily by the ionic liquid. Conditions such as the hexafluoropropylene content of the copolymer and the molecular weight of the copolymer are arbitrarily selected.

If necessary, a polymer compound not including α-phase PVDF may be used with the polymer compound including α-phase PVDF. Examples of the polymer compound not including α-phase PVDF include polytetrafluoroethylene (PTFE), an aromatic polyamide, and the like.

Next, the ionic liquid and the polymer compound are mixed (step S101). In this case, if necessary, any other material such as an additive of any kind may be added. A mixture (slurry) in which the polymer compound is dispersed (dissolved) by the ionic liquid is thereby obtained. The mixture ratio (weight ratio) of the ionic liquid and the polymer compound is arbitrarily selected. However, to sufficiently disperse the polymer compound by the ionic liquid, the polymer compound content is preferably higher than the ionic liquid content.

After that, the mixture of the ionic liquid and the polymer compound is preferably stirred (step S102), because the polymer compound is dispersed easily and more uniformly by the ionic liquid. In this case, the mixture is preferably stirred in a vacuum atmosphere, because air is less likely to be taken in (air is expelled) during stirring; therefore, the polymer compound is dispersed easily and more uniformly. Conditions such as a stirring method, a stirring time and pressure are arbitrarily selected.

Next, to ultimately obtain a film-shaped (sheet-shaped) polymer material, a surface of a base is preferably coated with the mixture (step S103). The base is a supporting body for molding the mixture in a film shape, and the base is, for example, a glass substrate. In this case, when the amount of the coated mixture is adjusted, the film thickness of the polymer material ultimately formed is adjustable accordingly. A method of applying the mixture to the surface of the base is not limited to coating, and immersing (so-called dipping) or the like may be used.

Finally, the mixture is heated (step S104). The heating temperature at this time is set to a temperature at which the ionic liquid and the polymer compound interact with each other, and is determined depending on the kinds, compatibility and the like of the ionic liquid and the polymer compound. Conditions such as a heating method and a heating time are arbitrarily selected. Therefore, the crystal structure of PVDF is transformed from α-phase to β-phase in the mixture, and the mixture is formed in a film shape on the surface of the base; therefore, a film-shaped polymer material including β-phase PVDF is obtained.

Functions and Effects of Method of Manufacturing Polymer Material

In the method of manufacturing the polymer material, the ionic liquid and the polymer compound (including α-phase PVDF) are mixed, and then heated. Therefore, the crystal structure of PVDF is transformed from α phase to β phase by heat treatment. In this case, the ionic liquid doubles as a solvent for dispersing the polymer compound; therefore, it is not necessary to additionally use a solvent for dispersion (a liquid other than the ionic liquid). Moreover, as the ionic liquid is nonvolatile, liquid stability during a manufacturing process is improved, compared to the case where a volatile organic solvent is used as a solvent for dispersion. Further, as the crystal structure of PVDF is transformed by a simple process such as mixing the polymer compound with the ionic liquid and heating the mixture, a complicated and large-scale process such as stretching or high-pressure crystallization is not necessary to transform the crystal structure. Therefore, β-phase PVDF is allowed to be manufactured easily and stably in a short time.

In particular, when the surface of the base is coated with the mixture of the ionic liquid and the polymer compound and then the mixture is heated, the film-shaped polymer material including β-phase PVDF is allowed to be obtained.

Even though β-phase PVDF obtained by the manufacturing method is substantially formed with use of only the ionic liquid and α-phase PVDF, β-phase PVDF obtains ionic conductivity substantially equal to that of the ionic liquid. Further, as an organic solvent is not used to obtain β-phase PVDF, β-phase PVDF is harmless to the environment and humans, and is allowed to be used repeatedly and safely.

2. Application Example (Electrochemical Capacitor)

Configuration of Electrochemical Capacitor

Next, an application example of the above-described method of manufacturing the polymer material will be described below. An electrochemical capacitor is described as the application example, and the method of manufacturing the polymer material is used for the electrochemical capacitor in the following manner.

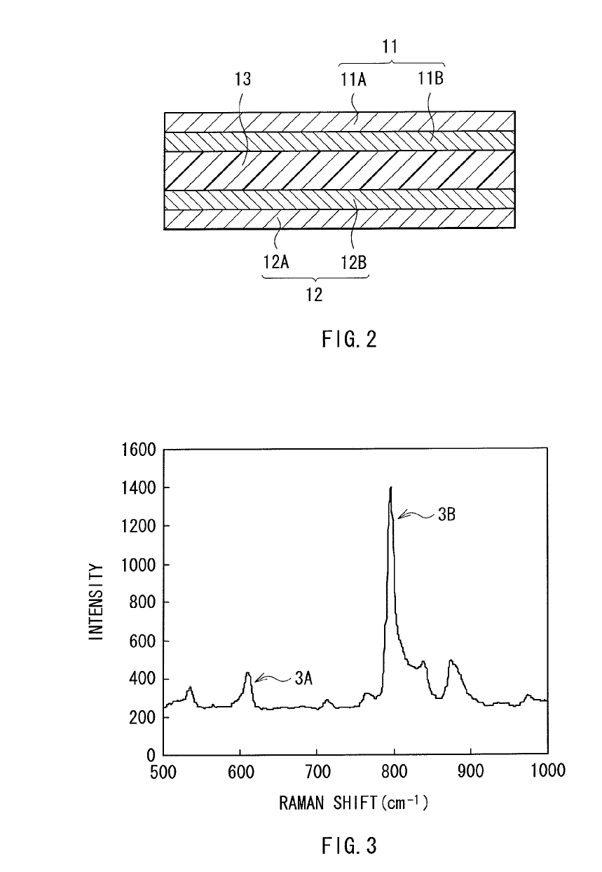

FIG. 2 illustrates a sectional configuration of the electrochemical capacitor. The electrochemical capacitor is used as a power supply for memory backup or the like in a small capacity application typified by an electronic device such as a cellular phone or a personal computer. Moreover, the electrochemical capacitor is also used in, for example, a large capacity application typified by a vehicle (a battery, a motor or the like) such as an electric vehicle or a hybrid electric vehicle. Other applications include, for example, a household power supply (an electric storage device or a battery saver).

The electrochemical capacitor is formed by laminating a cathode 11 and an anode 12 with an electrolyte layer 13 in between.

The cathode 11 includes, for example, a cathode active material layer 11B on one surface of a cathode current collector 11A. The cathode current collector 11A is formed of, for example, a conductive material such as aluminum (Al). The cathode active material layer 11B includes an active material, and may include any other material such as a conductor, if necessary.

The active material is a carbon material such as activated carbon. The kind of the activated carbon is not specifically limited, but examples of the activated carbon include phenol-based, rayon-based, acrylic-based, pitch-based and coconut-shell-based activated carbon. Conditions such as the specific surface area and particle diameter of the activated carbon are arbitrarily selected.

The conductor is a carbon material such as graphite, carbon black, acetylene black, ketjen black or vapor growth carbon fiber (VGCF). Conditions such as the particle diameter of the conductor are arbitrarily selected.

The anode 12 includes an anode active material layer 12B on one surface of an anode current collector 12A. The configurations of the anode current collector 12A and the anode active material layer 12B are the same as those of the cathode current collector 11A and the cathode active material layer 11B, respectively. However, the kind of the active material in the anode 12 may be the same as or different from the kind of the active material in the cathode 11.

The electrolyte layer 13 includes an ionic liquid and a polymer material (a binder), and the polymer material includes the polymer material obtained by the above-described manufacturing method. The polymer material used in the electrolyte layer 13 may include only the polymer material including β-phase PVDF, or may include another polymer material not including β-phase PVDF in addition to the polymer material including β-phase PVDF. Details of the ionic liquid are the same as those described in the method of manufacturing the polymer material. The kind of the ionic liquid used for manufacturing the polymer material and the kind of the ionic liquid used for the electrolyte layer 13 may be the same as or different from each other, but they are preferably the same as each other, because compatibility between materials is improved; therefore, the ionic liquid is easily held by the polymer material.

The electrolyte layer 13 is preferably molded in a sheet shape in advance, because the electrolyte layer 13 is easily handled. The electrolyte layer 13 includes the ionic liquid, so the electrolyte layer 13 may not additionally include a solvent for dispersion such as an organic solvent.

In the electrochemical capacitor, the cathode active material layer 11B and the anode active material layer 12B face each other with the electrolyte layer 13 in between, and the electrolyte layer 13 is arranged adjacent to the cathode 11 and the anode 12. In this case, as the electrolyte layer 13 has a function of separating the cathode 11 and the anode 12 from each other, a separator is not necessary.

Method of Manufacturing Electrochemical Capacitor

The electrochemical capacitor is manufactured by, for example, the following steps.

First, the cathode 11 is formed. The active material and, if necessary, the conductor, an organic solvent for viscosity adjustment, or the like are mixed and then stirred to form slurry. Next, the cathode current collector 11A is coated with the slurry by a bar coater or the like, and then the slurry is dried (the solvent is volatilized) to form the cathode active material layer 11B. Next, the cathode active material layer 11B is compression molded by a roller press or the like. Finally, the cathode current collector 11A on which the cathode active material layer 11B is formed is stamped into a pellet shape.

Next, by the same steps as those in the cathode 11, the anode active material layer 12B is formed on the anode current collector 12A to form the anode 12 with a pellet shape.

Then, the electrolyte layer 13 is formed. First, the ionic liquid and the polymer material (including β-phase PVDF) manufactured by the above-described manufacturing method are mixed and then stirred to form slurry. In this case, if necessary, another kind of polymer material and another material such as an organic solvent for viscosity adjustment may be added. Then, a surface of a base such as a glass plate is coated with the slurry, and then the slurry is dried to form a film of the slurry (to mold the slurry in a sheet shape). Finally, the film is stamped into a circular shape corresponding to the shapes of the cathode 11 and the anode 12.

Finally, the cathode 11 and the anode 12 are laminated so that the cathode active material layer 11B and the anode active material layer 12B face each other with the electrolyte layer 13 in between. Thus, the electrochemical capacitor is completed. Instead of forming the electrolyte layer 13 in a sheet shape in advance, the cathode active material layer 11B and the anode active material layer 12B may be coated with the slurry, and then the slurry may be dried to form the electrolyte layer 13.

Functions and effects of method of manufacturing electrochemical capacitor

In the method of manufacturing the electrochemical capacitor, the polymer material of the electrolyte layer 13 is manufactured by the above-described manufacturing method; therefore, the electrochemical capacitor is allowed to be manufactured easily and stably in a short time. In particular, β-phase PVDF which it takes a long time to manufacture in related art is obtained in a short time; therefore, the time of manufacturing the electrochemical capacitor and cost for the electrochemical capacitor are allowed to be reduced.

### EXAMPLES

Next, examples of the application will be described below.

### Experimental Examples 1 to 8

First, an ionic liquid (DEME-BF₄) and a polymer compound (PVDF-HFP) including α-phase PVDF were mixed at a weight ratio of 3:1 to form a mixture, and then the mixture was stirred for one hour in a vacuum environment by a magnetic stirrer. Next, a surface of a glass slide (2.5 cm×7.5 cm×0.1 cm) was coated with the mixture so that the mixture had a thickness of 100 μm. Then, processing was performed on the mixture at a processing temperature illustrated in Table 1. As a method of performing the processing, processing at 0° C. or less and processing at 50° C. or over are performed in a freezer and a hot plate, respectively, and processing at 25° C. is performed at room temperature.

When the state and the crystal structure of the processed mixture were examined, results as illustrated in Table 1 were obtained. To examine the state, the mixture was visually checked to determine whether the mixture was transformed from a liquid state. To examine the crystal structure, the crystal structure of PVDF was analyzed by Raman spectroscopy. FIGS. 3 to 5 are measurement results by Raman spectroscopy on Experimental Examples 3 and 6 and the ionic liquid only (DEME-BF₄).

TABLE 1
Table 1

| | | Polymer | Processing | | Crystal |
|---|---|---|---|---|---|
| | Ionic | Com- | Tempera- | | Struc- |
| | Liquid | pound | ture (° C.) | State | ture |
| Experimental | DEME-BF₄ | PVDF-HFP | −25 | Liquid | α phase |
| Example 1 | | | | | |
| Experimental | | | 0 | Liquid | α phase |
| Example 2 | | | | | |
| Experimental | | | 25 | Liquid | α phase |
| Example 3 | | | | | |
| Experimental | | | 50 | Liquid | α phase |
| Example 4 | | | | | |
| Experimental | | | 90 | Gel | α phase |
| Example 5 | | | | | |
| Experimental | | | 100 | Film | β phase |
| Example 6 | | | | | |
| Experimental | | | 125 | Gel | β phase |
| Example 7 | | | | | |
| Experimental | | | 200 | Gel | β phase |
| Example 8 | | | | | |

As illustrated in Table 1, when the processing temperature was 100° C. or over, the crystal structure of PVDF was transformed from α phase to β phase. The processed mixture was in a film state at a processing temperature of 100° C., and in a gel state at a processing temperature of 90° C., 125° C. and 200° C. At the processing temperature of 100° C., the formation of a film of the mixture was completed in a short time (approximately 10 seconds), and the thickness of the film was equal to the thickness (100 vin) of the mixture at the time of coating. Moreover, once the film was formed, even if the film was left at room temperature, the mixture was kept in a film state, and did not return to a liquid state. It is considered from this result that the crystal structure of PVDF is transformed from α phase to β phase at 100° C. or around 100° C.

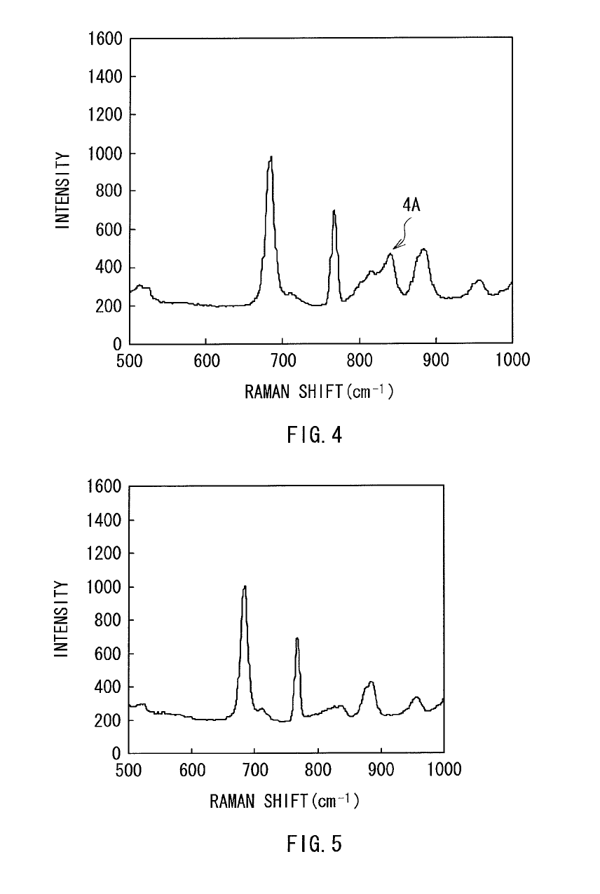

It was confirmed from the results illustrated in FIGS. 3 to 5 that the crystal structure of PVDF was transformed at a processing temperature of 100° C. or over. In the case where the ionic liquid and the polymer compound were mixed, irrespective of the processing temperature, peaks attributed to both of the ionic liquid and the polymer compound were obtained. However, at the processing temperature of 25° C. (refer to FIG. 3), peaks 3A and 3B attributed to α phase were obtained at 612 cm⁻¹ and 795 cm⁻¹, and the crystal structure of PVDF remained in α phase. On the other hand, at the processing temperature of 100° C. (refer to FIG. 4), instead of the above-described peaks attributed to α phase, a peak 4A attributed to β phase was obtained at 840 cm⁻¹; therefore, the crystal structure of PVDF was transformed to β phase.

The crystal structure of PVDF is transformed at a specific processing temperature or over in such a manner, because a strong interaction between a highly-polar ionic liquid and α-phase PVDF is produced (so-called phase transition of the crystal structure of PVDF occurs).

For confirmation, when the mixture was left for 3 days while keeping the processing temperature of 0° C., 25° C. and 100° C., the crystal structure of PVDF was not transformed at a temperature of lower than 100° C. Moreover, when the thickness at the time of coating was changed, the thickness was controllable within a wide range (approximately 15 μm to 1000 μm) according to the thickness at the time of coating.

Although the present application is described referring to the embodiment and examples, the application is not limited thereto, and may be variously modified. For example, the kinds of the ionic liquid and the polymer compound including α-phase PVDF used in the application are not limited to the above-described materials, and other materials may be used. Moreover, the application is applicable to not only the electrochemical capacitor but also the above-described other energy devices such as fuel cells and other devices except for the energy devices.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A method of manufacturing a polymer material comprising:
mixing an ionic liquid and a polymer compound including α-phase polyvinylidene difluoride to form a mixture, and then heating the mixture.

2. The method of manufacturing a polymer material according to claim 1, wherein before heating the mixture, the mixture of the ionic liquid and the polymer compound is stirred.

3. The method of manufacturing a polymer material according to claim 1, wherein before heating the mixture, a surface of a base is coated with the mixture of the ionic liquid and the polymer compound.

4. The method of manufacturing a polymer material according to claim 1, wherein the ionic liquid has compatibility with the polymer compound.

5. The method of manufacturing a polymer material according to claim 1, wherein the polymer compound has thermoplasticity.

6. The method of manufacturing a polymer material according to claim 1, wherein the polymer compound is a copolymer of vinylidene difluoride and hexafluoropropylene.
